(19) United States
(12) Patent Application Publication
(10) Pub. No.: US 2024/0334310 A1
(43) Pub. Date: Oct. 3, 2024

(54) METHOD, DEVICE, AND SYSTEM FOR ASSISTANT CELL CONFIGURATION IN WIRELESS NETWORKS

(71) Applicant: ZTE Corporation, Shenzhen (CN)

(72) Inventors: Li Niu, Shenzhen (CN); Yuan Gao, Shenzhen (CN); Xiubin Sha, Shenzhen (CN)

(73) Assignee: ZTE Corporation, Shenzhen (CN)

(21) Appl. No.: 18/742,172

(22) Filed: Jun. 13, 2024

Related U.S. Application Data
(63) Continuation of application No. PCT/CN2022/092052, filed on May 10, 2022.

(51) Int. Cl. H04W 48/08

(52) U.S. Cl. CPC H04W 48/08

(57) ABSTRACT

This disclosure relates generally to a method, device, and system for assistant cell configuration and optimization in a wireless network. One method performed by a UE is disclosed. The method may include: receiving, from a primary cell of a first NE, a first message comprising configuration information for an assistant cell, wherein the configuration information comprises at least one of following configurations: a downlink frequency; an uplink frequency; a cell identifier; a reference signal configuration; an SCS; a TDD configuration; a slot configuration; an initial BWP; a PRACH resource; a PUSCH resource; and a PDCCH resource for RAR message; and wherein the configuration information does not comprise following configurations: a BCCH resource; and a PDCCH resource for SIB; and wherein the assistant cell is deployed jointly with the primary cell and is characterized by: the assistant cell does not broadcast system information for the assistant cell.

### TECHNICAL FIELD

This disclosure is directed generally to wireless communications, and particularly to a method, device, and system for assistant cell configuration and optimization in a wireless network.

### BACKGROUND

Spectrum and energy efficiency are key performance indexes in the wireless communication network. Optimizing spectrum utilization and controlling power consumption to reduce energy cost are critical for developing and deploying a wireless communication network. More spectrum allocated in a wireless network leads to better network coverage and higher data rate. From a User Equipment (UE) perspective, UE battery life has great impact on user experience. From a network perspective, energy consumption is a key factor to consider for improving investment efficiency for operators. It is beneficial to fully utilize spectrum available to the operator, yet still meet power consumption requirement.

### SUMMARY

This disclosure is directed to a method, device, and system for assistant cell configuration and optimization in a wireless network.

In some embodiments, a method performed by a UE in a wireless network is disclosed. The method may include: receiving, from a primary cell of a first Network Element (NE), a first message comprising configuration information for an assistant cell, wherein the configuration information comprises at least one of following configurations: a downlink frequency; an uplink frequency; a cell identifier; a reference signal configuration; a subcarrier spacing (SCS); a Time Division Duplex (TDD) configuration; a slot configuration; an initial Bandwidth Part (BWP); a Physical Random Access Channel (PRACH) resource; a Physical Uplink Shared Channel (PUSCH) resource; and a PDCCH resource for Random Access Response (RAR) message; and wherein the configuration information does not comprise following configurations: a Broadcast Control Channel (BCCH) resource; and a PDCCH resource for System Information Block (SIB); and wherein the assistant cell is deployed jointly with the primary cell and is characterized by: the assistant cell does not broadcast system information for the assistant cell; and the assistant cell allows UEs to initiate at least one of: a random access process, a Radio Resource Control (RRC) procedure, and an RRC connection in it.

In some embodiments, a method performed by a first Network Element (NE) in a wireless network is disclosed. The method may include: transmitting, via a primary cell of the first NE to a User Equipment (UE), a first message comprising configuration information for an assistant cell, wherein the configuration information comprises at least one of following configurations: a downlink frequency; an uplink frequency; a cell identifier; a reference signal configuration; n SCS; a TDD configuration; a slot configuration; an initial Bandwidth Part (BWP); a PRACH resource; a PUSCH resource; and a PDCCH resource for RAR message; and wherein the configuration information does not comprise following configurations: a BCCH resource; and a PDCCH resource for SIB; and wherein the assistant cell is deployed jointly with the primary cell and is characterized by: the assistant cell does not broadcast system information for the assistant cell; and the assistant cell allows UEs to initiate at least one of: a random access process, a Radio Resource Control (RRC) procedure, and an RRC connection in it.

In some embodiments, there is a network element or a UE comprising a processor and a memory, wherein the processor is configured to read code from the memory and implement any methods recited in any of the embodiments.

In some embodiments, a computer program product comprising a computer-readable program medium code stored thereupon, the code, when executed by a processor, causing the processor to implement any method recited in any of the embodiments.

The above embodiments and other aspects and alternatives of their implementations are described in greater detail in the drawings, the descriptions, and the claims below.

### BRIEF DESCRIPTION OF THE DRAWINGS

FIG. 1 shows an example wireless communication network.

FIG. 2 shows an example wireless network node.

FIG. 3 shows an example user equipment.

FIG. 4 shows an exemplary message flow under assistant cell deployment, and exemplary assistant cell characteristics.

FIG. 5 shows an exemplary flow chart for a UE to establish connection with an assistant cell.

FIG. 6 shows an exemplary assistant cell selection scheme.

FIG. 7 shows another exemplary assistant cell selection scheme.

### DETAILED DESCRIPTION

### Wireless Communication Network

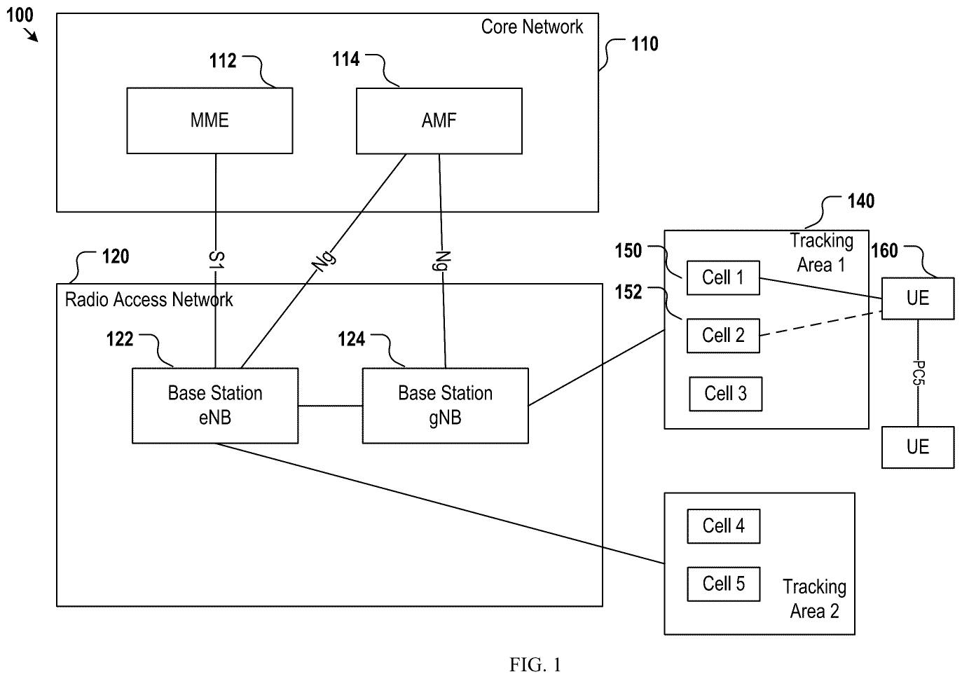

FIG. 1 shows an exemplary wireless communication network 100 that includes a core network 110 and a radio access network (RAN) 120. The core network 110 further includes at least one Mobility Management Entity (MME) 112 and/or at least one Access and Mobility Management Function (AMF). Other functions that may be included in the core network 110 are not shown in FIG. 1. The RAN 120 further includes multiple base stations, for example, base stations 122 and 124. The base stations may include at least one evolved NodeB (eNB) for 4G LTE, an enhanced LTE eNB (ng-eNB), or a Next generation NodeB (gNB) for 5G New Radio (NR), or any other type of signal transmitting/receiving device such as a UMTS NodeB. The eNB 122 communicates with the MME 112 via an SI interface. Both the eNB 122 and gNB 124 may connect to the AMF 114 via an Ng interface. Each base station manages and supports at least one cell. For example, the base station gNB 124 may be configured to manage and support cell 1, cell 2, and cell 3.

The gNB 124 may include a central unit (CU) and at least one distributed unit (DU). The CU and the DU may be co-located in a same location, or they may be split in different locations. The CU and the DU may be connected via an F1 interface. Alternatively, for an eNB which is capable of connecting to the 5G network, it may also be similarly divided into a CU and at least one DU, referred to as ng-eNB-CU and ng-eNB-DU, respectively. The ng-eNB-CU and the ng-eNB-DU may be connected via a W1 interface.

The wireless communication network 100 may include one or more tracking areas. A tracking area may include a set of cells managed by at least one base station. For example, tracking area 1 labeled as 140 includes cell 1, cell 2, and cell 3, and may further include more cells that may be managed by other base stations and not shown in FIG. 1. The wireless communication network 100 may also include at least one UE 160. The UE may select a cell among multiple cells supported by a base station to communication with the base station through Over the Air (OTA) radio communication interfaces and resources, and when the UE 160 travels in the wireless communication network 100, it may reselect a cell for communications. For example, the UE 160 may initially select cell 1 to communicate with base station 124, and it may then reselect cell 2 at certain later time point. The cell selection or reselection by the UE 160 may be based on wireless signal strength/quality in the various cells and other factors.

The wireless communication network 100 may be implemented as, for example, a 2G, 3G, 4G/LTE, or 5G cellular communication network. Correspondingly, the base stations 122 and 124 may be implemented as a 2G base station, a 3G NodeB, an LTE eNB, or a 5G NR gNB. The UE 160 may be implemented as mobile or fixed communication devices which are capable of accessing the wireless communication network 100. The UE 160 may include but is not limited to mobile phones, laptop computers, tablets, personal digital assistants, wearable devices, Internet of Things (IoT) devices, MTC/eMTC devices, distributed remote sensor devices, roadside assistant equipment, XR devices, and desktop computers. The UE 160 may also be generally referred to as a wireless communication device, or a wireless terminal. The UE 160 may support sidelink communication to another UE via a PC5 interface.

While the description below focuses on cellular wireless communication systems as shown in FIG. 1, the underlying principles are applicable to other types of wireless communication systems for paging wireless devices. These other wireless systems may include but are not limited to Wi-Fi, Bluetooth, ZigBee, and WiMax networks.

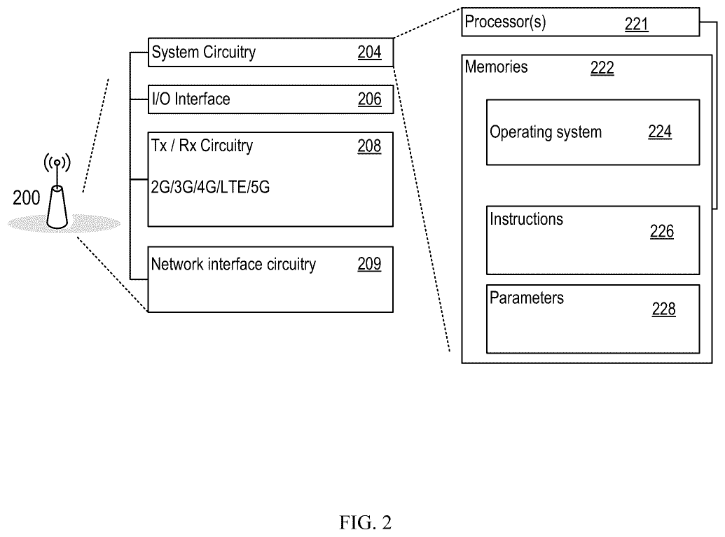

FIG. 2 shows an example of electronic device 200 to implement a network base station (e.g., a radio access network node), a core network (CN), and/or an operation and maintenance (OAM). Optionally in one implementation, the example electronic device 200 may include radio transmitting/receiving (Tx/Rx) circuitry 208 to transmit/receive communication with UEs and/or other base stations. Optionally in one implementation, the electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

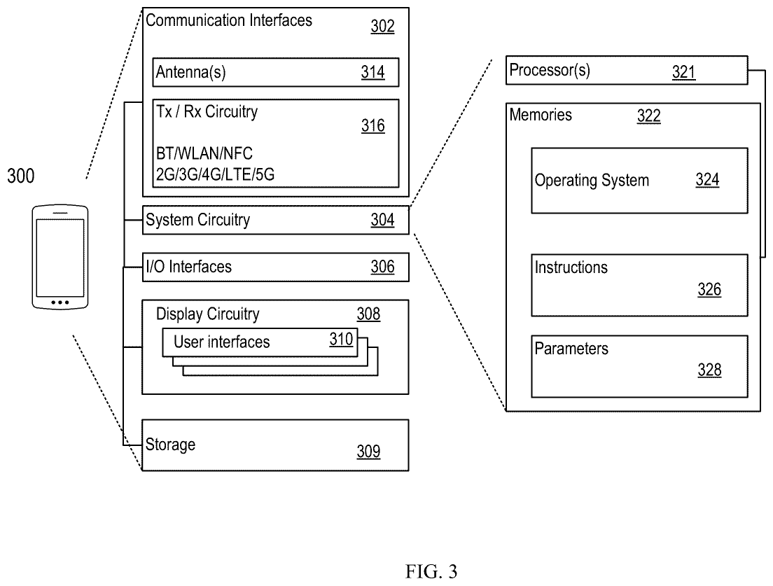

FIG. 3 shows an example of an electronic device to implement a terminal device 300 (for example, a user equipment (UE)). The UE 300 may be a mobile device, for example, a smart phone or a mobile communication module disposed in a vehicle. The UE 300 may include a portion or all of the following: communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

### Spectrum Efficiency and Power Saving in Wireless Network

In a wireless network, increasing capacity has become a top priority for network operators as mobile data consumption continues to grow. This is especially true in a fifth generation (5G) wireless network, where there is a continuing demand for high capacity and data rate, due to the ever-increasing number of mobile devices seeking rich and diverse services. The cost and scarcity of the available spectrum are major concerns toward addressing the capacity and coverage demand in the wireless network.

On the other hand, it is observed that previous generation technologies, such as second generation (2G), third generation (3G), even fourth generation (4G) networks have started to be or have already been phased out. Therefore, spectrum allocated to these previous generation networks may be re-used. For example, the radio resource may be used in a 5G network for establishing radio data bearer and carrying traffic. One solution is to deploy 5G capable cells under these 2G/3G/4G frequency bands. This type of cells may be referred to as assistant cell, in the sense that they are not deployed independently, but rather jointly with a so called primary cell. The assistant cell may act as a supplement of the primary cell. For example, a primary cell may offload some traffic to the assistant cell, so as to increase the overall network capacity.

As the number of cells increases due to the introduction of the assistant cells, the power consumption of these cells may need to be well managed and controlled. In this regard, the assistance cell may only be desirable to provide certain critical features to support traffic offloading, and may not need to provide a full set of services, to conserve energy usage.

The primary cell may need to periodically broadcast its system information to UEs, which consumes considerable amount of energy. For another example, the primary cell may also need to send paging messages for paging UEs, when the UEs are paged. This also consumes considerable amount of energy.

In this disclosure, various embodiments are disclosed aiming for implementing the assistant cell which does not need to broadcast system information, and/or which does not need to send paging messages. For example, a UE may camp on a primary cell, but may obtain the system information and resource configuration for a jointly deployed assistant cell from the primary cell. Once the UE receives a paging message, it may directly connect to (i.e., access) the assistant cell based on the readily available system information and resource configuration (e.g., Physical Random Access Channel (PRACH) resource) for the assistant cell, without introducing extra burden (such as extra signaling) to the primary cell, and without having to go through extra UE state transitions. By using this one step connection to the assistant cell, the power consumption for the UE, the assistant cell, and the primary cell may all be reduced. For another example, based on the solutions presented in this disclosure, when an idle UE needs to initiate a Radio Resource Control (RRC) procedure, the idle UE may access the assistant cell directly without intervention from the primary cell, rather than having to connect to a primary cell, transit to connected state under the primary cell, then migrate to a secondary cell of a different frequency to obtain service.

### Embodiment 1: Assistant Cell-Type 1

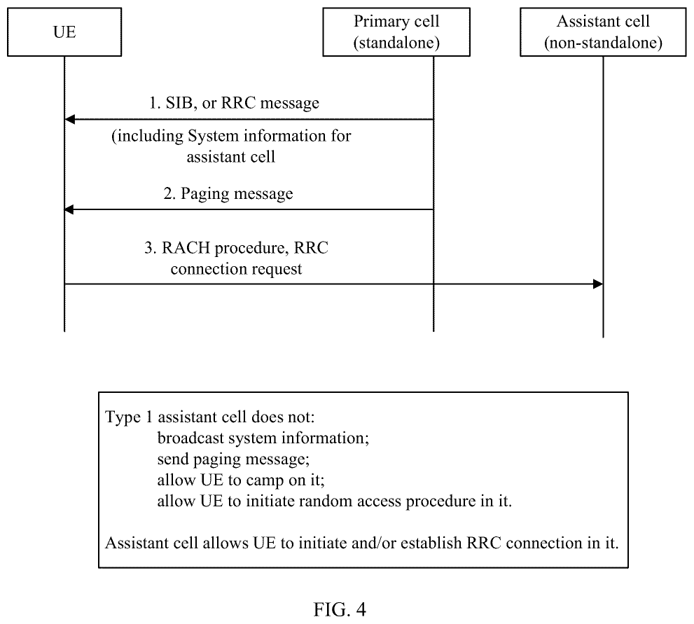

In a wireless network, one or more frequency bands may be utilized. In certain frequency band, various types of cells may be configured and deployed. These cells may include standalone cell or non-standalone cell. Referring back to FIG. 1, as an example deployment, cell 150 may be a standalone cell and cell 152 may be a non-standalone cell. A standalone cell, as its name suggests, may operate independently in the sense that it may broadcast/send its own configuration to a UE (e.g., system information), so the UE may be able to access the standalone cell based on the configuration. Whereas a non-standalone cell may not broadcast its own system information to a UE, and it relies on a standalone cell to help send its system information to the UE. For example, referring to FIG. 4, the standalone cell may send system information of the non-standalone cell by broadcasting via a System Information Block (SIB), or by sending an RRC message to the UE. In this disclosure, the standalone cell may be referred to as a primary cell, and a non-standalone cell may be referred to as an assistant cell, in the sense that a non-standalone cell may assist the primary cell, for example, to offload traffic and provide additional radio resource on top of the radio resource provided by the standalone cell. In this disclosure, two types of assistant cell are disclosed, with embodiment 1 covers assistant cell type 1 (hereinafter referred to as assistant cell in this embodiment for simplicity), and embodiment 2 covers assistant cell type 2.

Primary cell and assistant cell have different characteristics. In particular, for the assistant cell, it may not broadcast its own system information and send paging messages. A UE is allowed to initiate a random access process (or Random Access Channel (RACH) process, or RACH procedure), as well as establish an RRC connection on it. However, because the assistant cell does not broadcast system information and does not send paging message, a UE cannot directly camp on it. Therefore, to provide service to a UE, assistant cells may be deployed jointly with a standalone cell.

Under the joint deployment, the primary cell may have the following characteristics:
sending (via broadcasting or dedicated message) system information—for itself as well as jointly deployed assistant cells;
sending paging messages;
allowing UE to camp on it;
allowing UE to initiate random access process in the cell, and.
allowing UE to establish RRC connection in the cell.

The assistant cell has the following characteristics:
not sending broadcast system information;
not sending paging messages;
not allowing UE to camp on it;
allowing UE to initiate random access process in the cell; and
allowing UE to establish RRC connection in the cell.

As the assistant cell may not broadcast its own system information, the jointly deployed primary cell may help to broadcast via SIB or configure via RRC message the configuration of the assistant cell. The assistant cell configuration of the assistant cell may include at least one of:
a downlink frequency;
an uplink frequency;
a Physical Cell Index (PCI);
a reference signal configuration (e.g., SSB (Synchronization Signal/Physical Broadcast Channel Block) Measurement Timing Configuration (SMTC), the period and transmission occasion of Primary Synchronization Signal (PSS) and Secondary Synchronization Signal (SSS));
a subcarrier spacing (SCS);
a Time Division Duplex (TDD) configuration;
a slot configuration;
an initial Bandwidth Part (BWP);
a Physical Random Access Channel (PRACH);
a Physical Uplink Shared Channel (PUSCH); or
a PDCCH for Random Access Response (RAR) message.

In this embodiment, the assistant cell does not support sending system information and paging message, and the assistant cell configuration may not include:
a Broadcast Control Channel (BCCH) configuration;
a PDCCH configuration for SIB;
a Paging Control Channel (PCCH) configuration; and
a PDCCH configuration for paging.

In one implementation, if the primary cell does not broadcast or configure the access related information of the assistant cell, such as a Public Land Mobile Network (PLMN) identifier, a Tracking Area Code (TAC), or a reserved indication indicating whether the cell is reserved, the UE may consider the access related information of the assistant cell to be the same as the primary cell, and apply the access related information of the primary cell when the UE accesses the assistant cell.

In one implementation, if the primary cell does not broadcast or configure the unified access control information of the assistant cell, such as access category, access identity, the UE may consider the unified access control information of the assistant cell to be the same as the primary cell, and apply the unified access control information of the primary cell when UE accesses to the assistant cell.

In one implementation, if the primary cell does not broadcast or configure the cell identity (e.g., global cell identifier) of the assistant cell, the UE may consider the cell identity of the assistant cell to be the same as the primary cell, and apply cell identity of the primary cell when UE accesses to the assistant cell.

In one implementation, the primary cell may broadcast or configure an index for the assistant cell, and each assistant cell corresponds to an index. The index may also link a configuration (e.g., in a pool of configurations) with an assistant cell.

In one implementation, to identify whether a cell is an assistant cell, the primary cell may broadcast or configure an indicator along with a cell. In one implementation, an indicator may indicate whether a cell is an assistant cell or a primary cell by assigning different value to the indicator.

In one implementation, the primary cell may explicitly indicate to the UE whether an assistant cell is present by broadcasting or configuring an indicator.

In one implementation, the primary cell may indicate cell capabilities or cell functions to the UE by broadcasting or configuring an indicator. The indicator may indicate whether the UE could access or connect to the assistant cell; or whether the UE could perform an RRC procedure with the assistant cell. The RRC procedure may include an RRC connection setup, an RRC connection reestablishment, an RRC connection resume, a handover procedure, and the like.

In one implementation, the primary cell may broadcast or configure an indicator, the indicator may enable the UE to perform idle/inactive measurement on the assistant cell, when the UE is in idle or inactive state.

In one implementation, the primary cell may broadcast or configure the configuration of the assistant cell in a SIB, for example, in SIB 1, SIB 4, SIB 11, or another SIB format. The primary cell may also broadcast configurations for a list of assistant cells.

In one implementation, if the primary cell does not broadcast or configure the system information (which includes assistant cell configuration) of the assistant cell, and/or if the primary cell does not broadcast or configure the paging related configuration of the assistant cell, the UE may consider that the assistant cell is not allowed to camp on, or the assistant cell may not be a candidate cell during the cell reselection, or the UE may not receive the system information or paging message in the assistant cell.

### Embodiment 2: Assistant Cell-Type 2

In this embodiment, a type 2 assistant cell is described. a type 2 assistant cell shares most characteristics with type 1 assistant cell as described in embodiment 1. For example, a type 2 assistant cell may also need to be deployed jointly with a primary cell. However, a type 2 assistance cell has two distinct features: a UE is allowed to camp on a type 2 assistance cell, and a UE is also allowed to monitor paging message in a type 2 assistance cell. For simplicity, in the description below for this embodiment, assistant cell refers to type 2 assistant cell, unless otherwise specified.

Under the joint deployment, the primary cell may have the following characteristics:
sending (via broadcasting or dedicated message) system information—for itself as well as jointly deployed assistant cells;
sending paging messages;
allowing UE to camp on it;
allowing UE to initiate random access process in the cell; and
allowing UE to establish RRC connection in the cell.

The type 2 assistant cell has the following characteristics:
not sending broadcast system information;
sending paging messages;
allowing UE to camp on it;
allowing UE to initiate random access process in the cell;
allowing UE to establish RRC connection in the cell.

The jointly deployed primary cell may broadcast via SIB or configure via RRC message the configuration of the assistant cell. The particular configuration may include same configuration as assistant cell configuration described in embodiment 1, and is not repeated herein.

As type 2 assistant cell may support a UE to camp on it and may also support paging, and the assistant cell configuration for type 2 assistant cell may further include:
a PCCH configuration; and
a PDCCH configuration for paging.

In this embodiment, the type 2 assistant cell also does not support sending system information, and the type 2 assistant cell configuration may not include:
a Broadcast Control Channel (BCCH) configuration; and
a PDCCH configuration for SIB.

In one implementation, the primary cell may broadcast or configure the configuration of the type 2 assistant cell in an SIB, for example, in SIB 1, SIB 4, SIB 11, or other SIB format. The primary cell may also broadcast configurations for a list of assistant cells.

In one implementation, if the UE obtains the system information (which includes assistant cell configuration), or if the UE receives paging message from the primary cell, the UE may consider that the type 2 assistant cell is allowed to camp on, or the type 2 assistant cell may be a candidate cell during the cell reselection.

In one implementation, if the primary cell does not broadcast or configure the access related information of the assistant cell, such as a PLMN identifier, a Tracking Area Code (TAC), or a reserved indication indicating whether the cell is reserved, the UE may consider the access related information of the assistant cell to be the same as the primary cell, and apply the access related information of the primary cell when the UE accesses the assistant cell.

In one implementation, if the primary cell does not broadcast or configure the unified access control information of the assistant cell, such as access category, access identity, the UE may consider the unified access control information of the assistant cell to be the same as the primary cell, and apply the unified access control information of the primary cell when UE accesses to the assistant cell.

In one implementation, if the primary cell does not broadcast or configure the cell identity (e.g., global cell identifier) of the assistant cell, the UE may consider the cell identity of the assistant cell to be the same as the primary cell, and apply cell identity of the primary cell when UE accesses to the assistant cell.

In one implementation, the primary cell may broadcast or configure an index for the assistant cell, and each assistant cell corresponds to an index. The index may also link a configuration (e.g., in a pool of configurations) with an assistant cell.

In one implementation, to identify whether a cell is an assistant cell, the primary cell may broadcast or configure an indicator along with a cell. In one implementation, an indicator may indicate whether a cell is an assistant cell or a primary cell by assigning different value to the indicator.

In one implementation, the primary cell may explicitly indicate to the UE whether an assistant cell is present by broadcasting or configuring an indicator.

In one implementation, the primary cell may indicate cell capabilities or cell functions to the UE by broadcasting or configuring an indicator. The indicator may indicate whether the UE could access or connect to the assistant cell; or whether the UE could perform an RRC procedure with the assistant cell. The RRC procedure may include an RRC connection setup, an RRC connection reestablishment, an RRC connection resume, a handover procedure, and the like.

In one implementation, the primary cell may broadcast or configure an indicator, the indicator may enable the UE to perform idle/inactive measurement on the assistant cell, when the UE is in idle or inactive state.

### Embodiment 3: UE Selects Assistant Cell

In a wireless network, a UE may need to select a target cell from multiple cells for service access. For example, a UE may select the target cell among a primary cell and multiple assistant cells following certain criteria, which are described below. If an assistant cell is selected as the target cell, the UE may access the assistant cell based on its configuration. For the acquisition of the configuration of the assistant cell, reference may be made to embodiments 1 and 2. In one implementation, the UE may obtain the configuration of the assistant cell first, then select the assistant cell and access the assistant cell based on its configuration. This way, when the selection of the assistant cell is made, the configuration of the assistant cell is readily available for the UE to access the assistant cell. Alternatively, the UE may select the assistant cell first, then obtain the configuration of the assistant cell for accessing the assistant cell. That is, a selection of the assistant cell may further trigger the UE to acquire the configuration of the assistant cell.

This embodiment describes the condition and criteria for a UE to select an assistant cell. Unless otherwise specified, the assistant cell may include both type 1 and type 2 assistant cell.

An assistant cell may only provide limited functionalities, and a UE may not be allowed to camp on it. A UE may camp on primary cell first. After the UE triggers an RRC procedure, or UE receives a paging message, UE may select an assistant cell, select the PRACH resources of the assistant cell, establish an RRC connection, and complete the RRC procedure with the assistant cell.

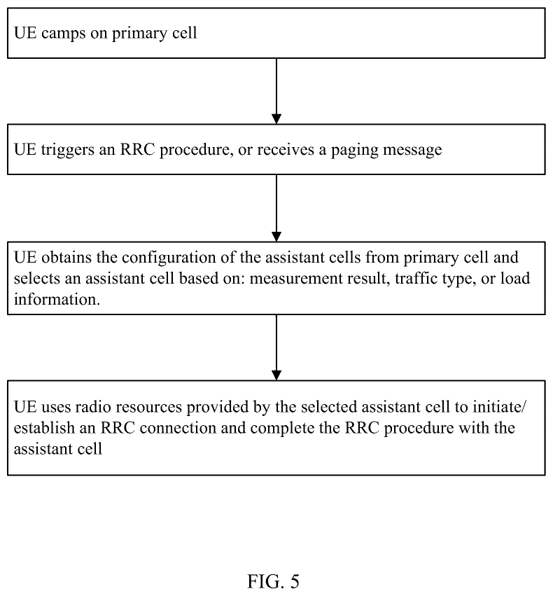

In one implementation, referring to FIG. 5, the UE is camping on the primary cell and an RRC procedure is triggered. Rather than completing the RRC procedure with the currently camped on primary cell, the UE may choose to proceed with an assistant cell. In doing so, the UE may obtain the configuration of the assistant cell (e.g., by following embodiments 1 and 2), select the assistant cell, trigger a random access procedure toward it, establish an RRC connection, and complete the RRC procedure with the assistant cell. The RRC procedure may include at least one of:
an RRC connection setup request procedure;
an RRC connection resume request procedure;
an RRC connection reconfiguration complete procedure; or
an RRC connection reestablishment request procedure.

In one implementation, the primary cell may broadcast or configure an indicator that enables the UE to select an assistant cell. That is, with the indication from the primary cell, the UE may have the option to select an assistant cell to proceed with an RRC procedure.

In one implementation, the primary cell may directly broadcast or configure the configuration of one or more assistant cells. Based on the configuration, UE may determine whether to switch to one of the assistant cells.

In this embodiment, various selection schemes are disclosed for a UE to select an assistant cell.

### Option 1: Based on Measurement Result

The UE may select an assistant cell according to the measurement result. At a given time, the UE may be covered by one primary cell and at least one assistant cell. The UE may measure these cells, for example, based on a reference signal, to obtain the measurement result for each of the cell. The measurement may include Signal to Interference Noise Ratio (SINR), Reference Signal Received Power (RSRP), Reference Signal Received Quality (RSRQ), etc. The UE may sort these cells (i.e., primary cell, and assistant cells) based on the measurement result, and select a cell with the highest measurement result.

In one implementation, the UE may exclude the primary cell and only make selection among assistant cells.

In one implementation, the primary cell may broadcast or configure a threshold for the measurement. For example, an assistant cell whose measurement result is higher than the threshold may be selected by UE.

In one implementation, the primary cell may broadcast or configure an assistant cell offset value and/or a primary cell offset value. The measurement result of the primary cell is adjusted by adding the primary cell offset value, and the measurement result of the assistant cell is adjusted by adding the assistant cell offset value. The UE may sort these cells according to the adjusted measurement result, and select the cell with the highest adjusted measurement result.

### Option 2: Based on Traffic Type

In a wireless network, different cells may be configured with different capabilities, and may support different types of traffic types. For example, a primary cell may support traffic that requires higher Quality of Service (QOS), whereas an assistant cell may be configured to support traffic with lower QoS requirement.

When initiating an RRC process for a service, the UE may select an assistant cell or a primary cell base one a traffic type associated with the service. Specifically, the primary cell may broadcast or configure the traffic type that primary cell or assistant cell may serve or support. The traffic type may include an establishment reason associated with a service, a service QoS, emergency service, and the like. For example, a cell allows an emergency call service. If UE initiates an emergency call service, UE may select this cell.

### Option 3: Based on Load Information

The primary cell and assistant cell may be configured to support load balancing and/or load aggregation. In load balancing, traffic load is evenly distributed across cells; in load aggregation, traffic load may be aggregated from multiple cells to a single cell, so as to save overall cell operating cost.

In one implementation, the primary cell could broadcast or configure the access factor (or may be referred to as load factor) for the primary cell and/or each assistant cell. The access factor may be determined by the load or access probability of the primary cell or each assistant cell. UE may select primary cell or assistant cell according to the access factor. The primary cell may broadcast the access factor of the primary cell and each candidate cell.

In one implementation, the larger the access factor, the greater (or heavier) the load is. As an example, the access factor may be a resource occupancy rate, a number of active UEs in a cell, a Physical Resource Block (PRB) usage ratio, etc. The UE may select the cell with the smallest access factor (or occupancy rate, etc.).

In one implementation, the smaller the access factor, the greater (or heavier) the load is.

### Option 4: Random Selection

In one implementation, if the selection parameters as described above are the same for the assistant cell and the primary cell, the UE may randomly select a cell between assistant cell and primary cell.

### Embodiment 4: Base Station Selects Assistant Cell

In addition to a UE making an assistant cell selection as described in embodiment 3, a base station may also indicate an assistant cell to the UE.

A base station, such as a gNB, an eNB, or an ng-eNB, based on its local policy, such as a policy based on load condition, may determine a list of potential cells that a UE may select from to complete an RRC procedure. The potential cells may include only assistant cells, or assistant cells plus primary cell. For example, if the load of the primary cell is above a threshold, the base station may determine a list of assistant cells for the UE to choose from in order to complete an RRC procedure. In certain situation, instead of explicitly sending the list of cells to the UE, a base station may also send a list of potential frequencies to the UE, and the UE may determine assistant cell(s) based on the list of potential frequencies.

There are multiple options for the base station to send the list of potential cells and/or frequencies, depending on the timing to send the list. For example, the base station may pre-configure the list to the UE, even when there is no RRC procedure pending. For another example, the base station may send the list to the UE on demand or in real time, when an RRC procedure is triggered or is pending.

### Option 1: Pre-Configuration

In this option, the base station may pre-configure the list to the UE, even when there is no RRC procedure pending.

In one implementation, the base station may pre-configure the list of potential cells or the list of potential frequencies to the UE by sending an RRC message, for example, an RRC release message, a paging message, or the like.

In one implementation, the RRC message may only include one cell ID, and in this case, the UE may select the cell indicated by the cell ID to complete a subsequent RRC procedure.

In one implementation, the RRC message may include a list of cells (e.g., assistant cells). In this case, the UE may select a cell to complete a subsequent RRC procedure, based on cell selection schemes described in embodiment 3 (i.e., based on measurement result, load information, or traffic type, or uses random selection).

In one implementation, the RRC message may include a list of potential frequencies. The UE may perform a search on these potential frequencies and then select a cell based on the frequency search result to complete a subsequent RRC procedure.

In one implementation, the same RRC message may further include an indicator which enables a UE to select a cell from the list of potential cells, or select a cell by searching the potential frequencies. Or the base station may use another RRC message to send the indicator to the UE.

Option 2: On-Demand Configuration for Procedure Initiated from Base Station

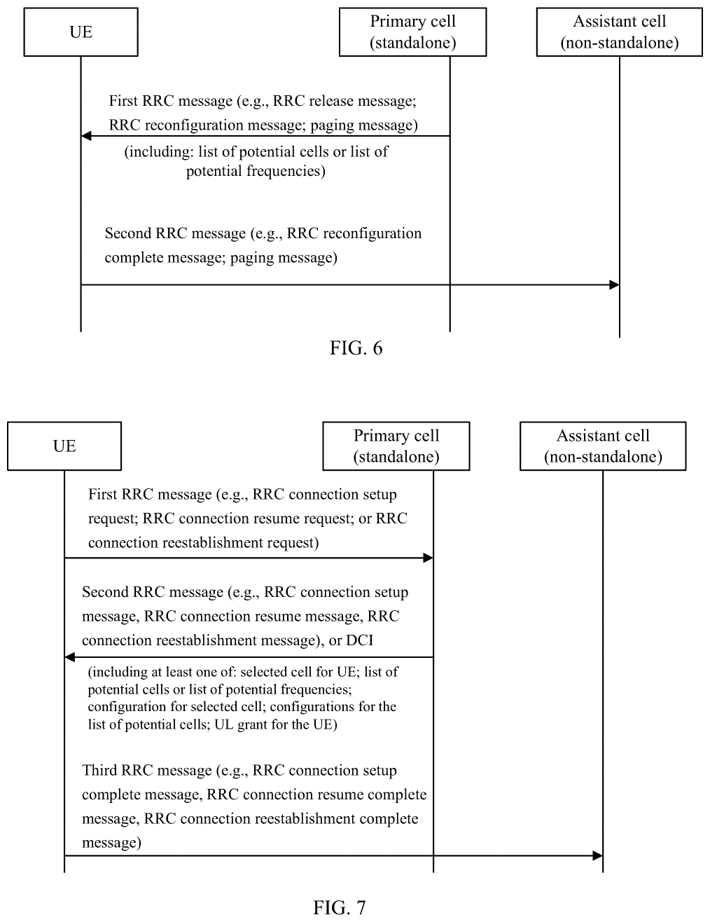

Referring to FIG. 6, in this option, the base station may initiate a first RRC message to the UE. In the first RRC message, the base station may specify the list of potential cells or the list of potential frequencies, just as how it does in option 1. Similarly, the UE may select a cell to complete the session, e.g., by sending a second RRC message to the selected assistant cell.

The first RRC message may include: an RRC release message; an RRC reconfiguration message; or a paging message.

The second RRC message may include: an RRC reconfiguration complete message; an RRC connection setup request message; an RRC connection resume request message; or the like.

For example, the first RRC message may specify an assistant cell for the UE to select for the subsequent session. Or in the case the first RRC message carries a list of potential cells or a list of potential frequencies, the UE select a cell based on the schemes as described in embodiment 3 (i.e., based on measurement result, load information, or traffic type, or uses random selection). The UE may then trigger a random access procedure with the selected assistant cell and send the second RRC message to it.

In one implementation, the system information for the assistant cell and the list of potential cells (or list of potential frequencies) may be sent together in one message. With reference to FIGS. 4 and 6, in FIG. 4 step 1, if the system information for the assistant cell is sent from the primary cell to the UE via an RRC message, the same RRC message may also be the first RRC message in FIG. 6.

In one implementation, the system information for the assistant cell and the list of potential cells (or list of potential frequencies) may be sent in different messages. With reference to FIGS. 4 and 6, the first RRC message in FIG. 6 may be a different message compared with the RRC message for sending the system information in FIG. 4 step 1.

Option 3: On-Demand Configuration-Procedure Initiated from UE

In this option, the UE may initiate an RRC procedure with the primary cell managed by the base station. The base station may determine that the traffic should be re-directed to an assistant cell and notify the UE for the re-direction.

Referring to FIG. 7, the UE may initiate an RRC procedure by sending a first RRC message to the primary cell. The first message may include: an RRC connection setup request; an RRC connection resume request; an RRC connection reestablishment request; or the like.

Upon receiving the first RRC message, the base station may decide to switch the traffic to an assistant cell, for example, based on the load condition of the primary cell. In doing so, the primary cell may reply back to the UE with a second RRC message. The second RRC message may include: an RRC connection setup message, an RRC connection resume message, an RRC connection reestablishment message, and the like.

In one implementation, the second RRC message may include a specific cell ID for the assistant cell. The second RRC message may further include a configuration for the assistant cell.

In one implementation, the second RRC message may include a list of potential cells or a list of potential frequencies. The UE may select a cell based on the list of potential cells or the list of potential frequencies. The second RRC message may further include configurations for the list of potential cells.

In one implementation, the base station may indicate an uplink (UL) grant either in the second RRC message, or via a Downlink Control Information (DCI) message.

After receiving the second RRC message or the DCI message, the UE may select an assistant cell to switch the service to. For example, if the second RRC message carries a cell ID of an assistant cell, the UE selects the corresponding assistant cell. If the second RRC message carries a list of potential cells or a list of potential frequencies, the UE may select a cell based on cell selection schemes described in embodiment 3 (i.e., based on measurement result, load information, or traffic type, or uses random selection). The UE may apply the configuration of the selected cell, or use the resource specified in the UL grant, and send a third RRC message to the selected assistant cell. The third RRC message may include: an RRC connection setup complete message, an RRC connection resume complete message, an RRC connection reestablishment complete message, and the like.

In one implementation, the system information for the assistant cell and the list of potential cells (or list of potential frequencies) may be sent together in one message. With reference to FIGS. 4 and 7, in FIG. 4 step 1, if the system information for the assistant cell is sent from the primary cell to the UE via an RRC message, the same RRC message may also be the second RRC message in FIG. 7.

In one implementation, the system information for the assistant cell and the list of potential cells (or list of potential frequencies) may be sent in different messages. With reference to FIGS. 4 and 7, the second RRC message in FIG. 7 may be a different message compared with the RRC message for sending the system information in FIG. 4 step 1.

### Embodiment 5: Cell Measurement

If the transmitted beams in an assistant cell are same as primary cell, UE may select the suitable PRACH resource based on the measured Synchronization Signal/Physical Broadcast Channel Block (SSB) of primary cell.

If the transmitted beams in the assistant cell are not same as primary cell, UE may need to select the suitable PRACH resource based on the measured SSB of the assistant cell. In this case, before the UE attempts to trigger a RACH procedure with the assistant cell, the UE may first need to measure the SSB in the assistant cell. In this disclosure, multiple options are disclosed for measuring assistant cell.

### Option 1: Event Triggered Measurement

The measurement may be triggered by an event, such as after UE receiving a paging message, after UE triggering an RRC procedure, or before UE triggering a RACH procedure. The UE may measure assistant cells directly, if the assistant cells are already known to the UE. Or the UE may measure candidate frequencies associated with suitable cells including assistant cells.

In one implementation, the candidate frequencies and/or assistant cells may be broadcast or configured by the base station. The measurement may be based on the SSB of the candidate frequencies and/or assistant cells.

### Option 2: Dormant Mode CA & DC Measurement

In idle or inactive mode, the UE may perform idle/inactive mode measurement on the candidate frequencies and/or assistant cells. In one implementation, Carrier Aggregation (CA) and Dual connectivity (DC) are supported. The UE may measure the candidate frequencies as CA and DC candidate frequencies, and measure the assistant cells as CA and DC candidate cells.

The primary cell may broadcast by SIB or configure by RRC message the configuration of candidate frequencies and/or assistant cells, for example, via SIB 11 or a new SIB. The configuration could include the frequency, SCS, SMTC, measured SSB, and PCIs of the assistant cells.

### Option 3: Dormant Mode Measurement

In idle or inactive mode, the UE may measure candidate frequency as intra-frequency or inter-frequency measurement, and measure assistant cell as a neighbor cell.

The primary cell could broadcast by SIB or configure by RRC message the configuration of candidate frequencies and/or assistant cells. For example, via SIB 4 or a new SIB. The configuration could include the frequency, SCS, SMTC, measured SSB, and PCIs of the assistant cells.

### Option 4: Dormant Mode Conditional Measurement

In idle or inactive mode, the UE may determine whether to start to perform the measurement on the candidate frequencies and/or assistant cells based on some conditions. The conditions may include at least one of the following:
The cell quality of primary cell is less than a quality threshold, and the quality threshold may be broadcast by SIB or configured by RRC signaling. The cell quality may be measured by, for example, SINR, RSRP, or RSRQ of a cell.
The load of primary cell is higher than a load threshold, and the load threshold may be broadcast by SIB or configured by RRC signaling. The load of primary cell may also be sent via SIB or RRC signaling. The load may include a load factor, an occupancy rate, a usage ratio, etc.
The base station may indicate to the UE the candidate frequencies and/or assistant cells via RRC message, for example, an RRC release message. The UE may perform measurement upon receiving the RRC message.

### Embodiment 6: System Information Acquisition for Assistant Cell

As the assistant cell may not send its own system information, the primary cell may delegate this task and supply the system information for multiple assistant cells, for example, via SIB or RRC message. In this disclosure, for the UE to acquire system information for assistant cells, multiple options are described below.

### Option 1

The UE may attempt to acquire system information of an assistant cell from the primary cell when triggered by at least one of following events/messages:
after UE receives a paging message;
before UE triggers a RACH procedure;
after UE triggers an RRC procedure, such as a Mobile Originating (MO) or a Mobile Terminating (MT) procedure; or
after an RRC procedure (e.g., RRC setup, RRC resume, handover, RRC reestablishment procedure) is triggered.

### Option 2

In idle or inactive mode, UE may acquire the system information of an assistant cell from the primary cell. Before UE receives a paging message, or before UE triggers an MT or an MO procedure, and if the primary cell broadcasts the system information of assistant cell, UE may acquire the system information of the assistant cell from the primary cell.

### Option 3

If UE detects an assistant cell, and the cell quality of the assistant cell is higher than a threshold, UE may acquire the system information of assistant cell. The threshold may be broadcast or configured by the primary cell.

### Option 4

If the system information of an assistant cell is updated, and a short message or paging message is transmitted from the primary cell to the UE, an indication may be added in the short message or the paging message. The indication may indicate a list of assistant cells of which the system information is updated. The UE may update system information of the corresponding assistant cell(s) based on the indication.

### Option 5

If the system information of an assistant cell is updated, and a short message or paging message is transmitted from the assistant cell to the UE, an indication may be added in the short message or the paging message. The indication may indicate a list of assistant cells of which the system information is updated, and the indication may further indicate which particular system information is updated. Upon receiving the indication, the UE may switch to the corresponding primary cell that broadcasts the system information for the assistant cell(s), and obtain the updated system information from the primary cell.

### Embodiment 7: Avoid Camping on Assistant Cell

An assistant cell may help to offload traffic from a jointly deployed primary cell and it has limited capability compared with the primary cell. For a type 1 assistant cell, a UE is not supposed to camp on it, and the UE is not able to receive paging message from the type 1 assistant cell. However, UE may measure an assistant cell as a neighbor cell, and obtain system information from, for example, SIBI and Master Information Block (MIB). By mistake, UE may consider the type 1 assistant cell as a candidate cell, for example, for cell selection/reselection purpose, after the cell measurement. UE may further camp on this assistant cell. This behavior may lead to service failure, as the UE is not able to monitor paging message in a type 1 assistant cell if this is the cell the UE camps on. In this embodiment, various options are disclosed to prevent a UE from mistakenly camping on a type 1 assistant cell. For simplicity, a type 1 assistant cell is referred to as assistant cell in this embodiment.

### Option 1

The cell status of the assistant cell may be configured as barred cell, and an additional access indicator may be introduced, for example, in the SIB, to indicate that RRC connection is allowed (while the cell is barred). When UE receives the cell status and the access indicator, the UE may determine that it is not allowed to camp on this assistant cell, and exclude this assistant cell during the cell reselection procedure, to prevent camping on it. However, the UE may also determine that an RRC connection to this assistant cell is allowed. Therefore, when the UE triggers an RRC procedure such as an RRC connection procedure, UE may transmit RRC messages towards this assistant cell. Likewise, when UE needs to initiate a RACH procedure, the UE may use the PRACH resource provided by this assistant cell.

### Option 2

A new cell type may be defined for the assistant cell (e.g., no-camp cell type). A UE is not allowed to camp on a cell of this new cell type, but is allowed to access the cell (e.g., by making RRC connections, or initiating RRC procedures, etc.). Under this new cell type, a UE may not camp on it, but it may obtain other services such as RRC services (e.g., initiating, establishing, or reconfiguring an RRC connection). An assistant cell of this cell type may fulfill the cell selection criteria, but is nonetheless excluded from the cell reselection procedure. An assistant cell of this cell type may not broadcast its system information and may delegate this task to other cells (such as a primary cell), neither may this assistant cell transmit paging message.

### Embodiment 8: Optimization

In a wireless network, small cells with low power consumption are deployed, especially in an indoor environment, to extend network coverage and increase network capacity. The assistant cell may be a small cell. As a small cell generally covers a small area, a UE may fail an RRC connection establishment due to UE's mobility, for example, as the UE move toward the edge of the small cell coverage. In this case, a Tracking Area Update (TAU) may be triggered, even there is a primary cell in place which may provide satisfactory coverage to the UE. The TAU procedure may cause extra signaling overhead and increase power consumption for both the UE and the serving network. In this embodiment, various schemes are described to optimize the UE/network performance and reduce the occurrence of TAU procedure.

### Option 1:

When the UE transmits an RRC message towards the assistant cell, and a timer such as timer T300 expires, or a RACH problem is indicated to the RRC layer, the UE may consider that an RRC connection failure or a RACH failure occurs. The UE may attempt the RRC connection again by following at least one of the conditions below:
The UE may consider the assistant cell as access not allowed, or RRC connection not allowed, for a predetermine period. This predetermine period may be sent from the base station via SIB or RRC signaling;
The UE does not indicate the failure on the assistant cell to the Non-Access Stratum (NAS) layer. This will at least save the NAS signaling overhead;
If cell quality of primary cell is higher than a threshold, UE may re-initiate the RRC connection on the primary cell. The threshold may be sent from the base station via SIB or RRC signaling;
UE may switch to the primary cell; or re-transmit the RRC message towards the primary cell; or select PRACH resources on the primary cell; or
The timer T300 is restarted.

### Option 2:

If an RRC connection establishment fails in the assistant cell, UE may indicate the failure to the base station via an RRC message, for example, a

UEInformationResponse message, a UEAssistanceInformation message, or another type of message. The message may indicate that the failed cell is an assistant cell, the number of failed connection (e.g., from the last reset, or during a predefined time period such as the last 10 minutes), the selected PRACH resource associated with the failed RRC connection, the cell identity of the primary cell associated with the assistant cell, Cell Global Identifier (CGI) of the assistant cell, PCI of the assistant cell, or the measurement results of assistant cell.

### Embodiment 9: SIB Validity

The system information of a cell may be updated from time to time. The system information includes critical information for a UE to obtain service from a cell, for example, when the UE initiates an RRC procedure. Obsolete system information may cause a failure during the RRC procedure. For a cell such as a primary cell, it may broadcast the system information periodically, so the UE may obtain up-to-date system information.

However, for a cell such as an assistant cell, it does not broadcast system information, and a UE may not be able to check the version of SIB for the assistant cell. To help the UE maintaining valid SIB for the assistant cell, various options are described below.

### Option 1

Each time before the UE triggers a RACH procedure and transmits an RRC message towards the assistant cell, it may acquire the system information of the assistant cell in the primary cell first, to ensure the system information of the assistant cell is up-to-date.

### Option 2

The UE may use a timer to ensure the validity of the system information of the assistant cell:
The base station may broadcast or configure the duration of the timer.
Each time the UE acquires the system information of the assistant cell in the primary cell, UE starts/restarts the timer.
Each time the UE acquires the system information of the assistant cell via an RRC message, UE starts/restarts a timer.
If the timer is running, UE may consider the system information of the assistant cell to be valid and up to date.
Once UE connects to the primary cell, UE stop the timer.
If the timer expires, UE considers system information of the assistant cell to be invalid.
The UE is in connected mode connecting to the assistant cell. If the timer expires, UE may transit to idle mode, switch to the primary cell, and acquire the system information for the assistant cell from the primary cell.
The UE is in idle or inactive mode. If the timer expires, UE may switch to the primary cell and acquire the system information for the assistant cell from the primary cell.
When the UE is connecting to the assistant cell, UE may report time information of the timer to the base station via an RRC message, such as an RRC setup complete message; an RRC resume complete message; an RRC reestablishment complete message; an RRC reconfiguration complete message; or other messages such as newly defined message. In one implementation, the time information may include the remaining time of the timer, which may be calculated based on the duration of the timer, the first transmission occasion of the current message for reporting the timer information. In one implementation, the time information may include the starting time of the timer.

### Option 3

UE always considers the essential system information of candidate cell valid. If UE has obtained the system information of the candidate cell, UE could always consider the system information valid. Until after 3 hours, UE considers the system information of candidate cell invalid, and discards it.

In this disclosure, various messages and/or signaling are used for exchanging information (such as configuration, instruction, indication, etc.) between network elements such as a base station and a UE. Various information may be combined in a same message or may be split into multiple messages, as long as same level of service is delivered. For example, two configurations may be sent in one message, or may be sent in two messages.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution may be practiced without one or more of the specific features or advantages of a particular embodiment. In other instances, additional features and advantages may be recognized in certain embodiments that may not be present in all embodiments of the present solution.

1. A method for wireless communication, performed by a User Equipment (UE) in a wireless network, the method comprising:
receiving, from a primary cell of a first Network Element (NE), a first message comprising configuration information for an assistant cell, wherein the configuration information comprises at least one of following configurations:
a downlink frequency;
an uplink frequency;
a cell identifier;
a reference signal configuration;
a subcarrier spacing (SCS);
a Time Division Duplex (TDD) configuration;
a slot configuration;
an initial Bandwidth Part (BWP);
a Physical Random Access Channel (PRACH) resource;
a Physical Uplink Shared Channel (PUSCH) resource; and
a PDCCH resource for Random Access Response (RAR) message; and
wherein the configuration information does not comprise following configurations:
a Broadcast Control Channel (BCCH) resource; or
a PDCCH resource for System Information Block (SIB); and
wherein the assistant cell is deployed jointly with the primary cell and is characterized by:
the assistant cell does not broadcast system information for the assistant cell; or
the assistant cell allows UEs to initiate at least one of: a random access process, a Radio Resource Control (RRC) procedure, and an RRC connection in it.

2. The method of claim 1, wherein the first message comprises at least one of:
a Radio Resource Control (RRC) message; or
a System Information Block (SIB) message.

3. The method of claim 1, wherein the assistant cell is further characterized by:
the assistant cell allows the UEs to camp on it; or
the assistant cell broadcasts paging message.

4. The method of claim 3, wherein the configuration information further comprises following configurations:
a Paging Control Channel (PCCH) resource; or
a PDCCH resource for paging.

5. The method of claim 3, further comprising:
in response to obtaining the system information for the assistant cell from the primary cell, or paging configuration of the assistant cell from the primary cell, considering the assistant cell as a target cell to camp on or a target cell for cell reselection purpose.

6. The method of claim 1, wherein the assistant cell is further characterized by:
the assistant cell does not allow UEs to camp on it; or
the assistant cell does not broadcast paging message.

7. The method of claim 6, wherein the configuration information does not comprise following configurations:
a PCCH resource; or
a PDCCH resource for paging.

8. The method of claim 1, wherein:
in response to the configuration information not comprising access related information, accessing the assistant cell based on the access related information of the primary cell; and
wherein the access related information comprises at least one of:
a Public Land Mobile Network (PLMN) identifier;
a Tracking Area Code (TAC); or
a reserved cell indication.

9. The method of claim 1, wherein:
in response to the configuration information not comprising unified access control information, accessing the assistant cell based on the unified access control information of the primary cell; and
the unified access control information comprises at least one of: an access category, or an access identity.

10. The method of claim 1, wherein:
in response to the configuration information not comprising a global identity of the assistant cell, accessing the assistant cell based on the global identity of the primary cell.

11. The method of claim 1, wherein the first message further comprises at least one of:
an assistant cell indicator indicating whether a cell is an assistant cell;
an assistant cell presence indicator indicating whether the assistant cell is present;
an assistant cell access functionality indicator indicating at least one of:
whether the UE is allowed to access or connect to the assistant cell; or
whether the UE is allowed to perform an RRC procedure with the assistant cell, the RRC procedure comprising at least one of:
an RRC connection setup procedure;
an RRC connection resume procedure;
an RRC reestablishment procedure; or
a handover procedure; or
a cell measurement indicator indicating whether the UE is enabled to perform cell measurement on the assistant cell when the UE is in an idle or an inactive state.

12-14. (canceled)

15. The method of claim 1, wherein the UE is camped on the primary cell, the method further comprising:
in response to an RRC procedure being triggered or a paging message being received, determining a candidate cell from the assistant cell and the primary cell for performing the RRC procedure or handling the paging message, wherein the RRC procedure comprises at least one of:
an RRC connection setup request procedure;
an RRC connection resume request procedure;
an RRC connection reconfiguration complete procedure; or
an RRC connection reestablishment request procedure; and
in response to the assistant cell being selected as the candidate cell, performing the RRC procedure or handling the paging message based on the configuration information for the assistant cell.

16. The method of claim 15, wherein determining the candidate cell comprises at least one of:
determining the candidate cell based on a measurement result of the assistant cell and the primary cell, the measurement result being based on a reference signal;
determining the candidate cell based on a traffic type of a service associated with the RRC procedure or the paging message;
determining the candidate cell based on a load condition of the assistant cell and the primary cell; or
in response to the measurement result of the assistant cell and the primary cell is the same, or the load condition of the assistant cell and the primary cell is the same, determining the candidate cell randomly from the assistant cell and the primary cell.

17. The method of claim 1, further comprising at least one of:
determining a candidate cell based on a measurement result of the assistant cell and the primary cell, the measurement result being based on a reference signal;
determining the candidate cell based on a traffic type of a service associated with the RRC procedure or a paging message targeting the UE;
determining the candidate cell based on a load condition of the assistant cell and the primary cell; or
in response to the measurement result of the assistant cell and the primary cell is the same, or the load condition of the assistant cell and the primary cell is the same, determining the candidate cell randomly from the assistant cell and the primary cell.

18. The method of claim 1, further comprising:
receiving, from the first NE, a second message comprising a list of cells serving as a pool for selecting a candidate cell from, the list of cells comprising at least one of the assistant cell and the primary cell, the candidate cell being used by the UE for performing an RRC procedure or a Random Access Channel (RACH) procedure;
in response to the list of cells comprising only one cell, selecting the only one cell as the candidate cell; and
in response to the list of cells comprising at least two cells, selecting the candidate cell based on one of:
a traffic type of a service associated with the RRC procedure or the RACH procedure;
a load condition of each cell in the list of cells; or
a measurement result of the each cell in the list of cells.

19. The method of claim 18, wherein a type of the second message comprises at least one of:
an RRC release message;
an RRC reconfiguration message; or
a paging message.

20. The method of claim 18, further comprising:
in determination that the assistant cell is selected as the candidate cell and based on the configuration information for the assistant cell, initiating a RACH procedure with the assistant cell, and transmitting a first RRC message to the assistant cell.

21. The method of claim 20, wherein a type of the first RRC message comprises one of:
an RRC reconfiguration complete message;
an RRC connection setup request message; or
an RRC connection resume request message.

22-53. (canceled)

54. A method for wireless communication, performed by a first Network Element (NE) in a wireless network, the method comprising:
transmitting, via a primary cell of the first NE to a User Equipment (UE), a first message comprising configuration information for an assistant cell, wherein the configuration information comprises at least one of following configurations:
a downlink frequency;
an uplink frequency;
a cell identifier;
a reference signal configuration;
a subcarrier spacing (SCS);
a Time Division Duplex (TDD) configuration;
a slot configuration;
an initial Bandwidth Part (BWP);
a Physical Random Access Channel (PRACH) resource;
a Physical Uplink Shared Channel (PUSCH) resource; and
a PDCCH resource for Random Access Response (RAR) message; and
wherein the configuration information does not comprise following configurations:
a Broadcast Control Channel (BCCH) resource; or
a PDCCH resource for System Information Block (SIB); and
wherein the assistant cell is deployed jointly with the primary cell and is characterized by:
the assistant cell does not broadcast system information for the assistant cell; or
the assistant cell allows UEs to initiate: random access process, Radio Resource Control (RRC) procedure, and RRC connection in it.

55-61. (canceled)

62. A wireless device comprising a memory for storing computer instructions and a processor in communication with the memory, wherein, when the processor executes the computer instructions, the processor is configured to cause the wireless device to:
receiving, from a primary cell of a first Network Element (NE), a first message comprising configuration information for an assistant cell, wherein the configuration information comprises at least one of following configurations:
a downlink frequency;
an uplink frequency;
a cell identifier;
a reference signal configuration;
a subcarrier spacing (SCS);
a Time Division Duplex (TDD) configuration;
a slot configuration;
an initial Bandwidth Part (BWP);
a Physical Random Access Channel (PRACH) resource;
a Physical Uplink Shared Channel (PUSCH) resource; and
a PDCCH resource for Random Access Response (RAR) message; and
wherein the configuration information does not comprise following configurations:
a Broadcast Control Channel (BCCH) resource; or
a PDCCH resource for System Information Block (SIB); and
wherein the assistant cell is deployed jointly with the primary cell and is characterized by:
the assistant cell does not broadcast system information for the assistant cell; or
the assistant cell allows UEs to initiate at least one of: a random access process, a Radio Resource Control (RRC) procedure, and an RRC connection in it.
